(19) United States
(12) Patent Application Publication
(10) Pub. No.: US 2005/0146738 A1
(43) Pub. Date: Jul. 7, 2005

(54) Color profile correcting method

(75) Inventor: Makoto Narazaki, Kyoto (JP)

Correspondence Address: McDermott Will & Emery LLP, 600 13th Street, N.W., Washington, DC, 20005-3096, US

(73) Assignee: DAINIPPON SCREEN MFG. CO., LTD.

(21) Appl. No.: 11/022,848

(22) Filed: Dec. 28, 2004

(30) Foreign Application Priority Data
Jan. 7, 2004 (JP) 2004-002267

(51) Int. Cl. H04N 1/60; H04N 1/56; H04N 1/50

(52) U.S. Cl. 358/1.9; 358/518; 358/523; 358/504

(57) ABSTRACT

Color values Lab (1) are converted into corrected tone values YMCK (2) using a second table 22 in a printer profile P2. Next, these tone values YMCK (2) are converted back into color values Lab (2) using a first table 21 in the printer profile P2. Then, the color values Lab (1) before the conversion and the color values Lab (2) after the conversion are compared and differences therebetween are determined. Based on these differences, data of the second table 22 in the printer profile P2 is corrected. The above operation is carried out again using the corrected second table 22. By correcting the second table repeatedly, the accuracy of the second table 22 may be improved further.

### BACKGROUND OF THE INVENTION

1. Field of the Invention

This invention relates to a color profile correcting method.

2. Description of the Related Art

A color profile such as the ICC (International Color Consortium) profile is used in various printing devices in order to match printing color. Generally, this color profile includes a first table serving as a lookup table for the conversion from tone values to color values of image data and a second table serving as a lookup table for the conversion from color values to tone values of image data. The following steps are executed to create this color profile.

To create the first table for the conversion from tone values to color values of image data, a color chart is first produced by using a printing device such as a printing machine or printer. The color chart is based on known tones such as YMCK values or RGB values, and covers an entire printable coloring range in a gradually changing pattern. Next, each patch in this color chart is measured with a colorimeter to obtain data of a color value for each tone value. Then, an interpolation process is carried out based on this data, to obtain the first table for the conversion from tone values to color values, covering a full range of tone values.

On the other hand, when creating the second table for the conversion from color values to tone values of image data, data of a tone value for each color value is derived from an arithmetic operation performed by using an inverse function for each data in the first table. However, the range that can be defined by a standard color system such as Lab is larger than the range of color that can actually be printed. Further, the tones in the color chart are not necessarily equally distributed over the color space expressed by the standard color system. Therefore, when creating the second table, not only is an interpolation process required as in time of creating the first table, but extrapolation points occur to lower the accuracy of creation. Further, when the tone values are YMCK values, the accuracy of creation worsens due also to the fact that the standard color system is three-dimensional. For these reasons, the second table for the conversion from color values to tone values of image data, generally, is less accurate than the first table for the conversion from tone values to color values of image data.

Conventionally, therefore, a color chart is actually printed using a color profile, and then the color profile is corrected by measuring, with a colorimeter, each patch in the color chart printed (Japanese Unexamined Patent Publication No. 2000-278547).

However, the above conventional practice requires an actual printing of the color chart. This poses a problem that the operation for correcting the color profile is complicated and time-consuming. Besides, even though the color profile is corrected by measuring, with a colorimeter, each patch in the color chart printed, the color profile can rarely be made proper by a single correcting operation.

### SUMMARY OF THE INVENTION

The object of this invention, therefore, is to provide a color profile correcting method capable of correcting a color profile promptly and properly without executing a printing operation.

The above object is fulfilled, according to this invention, by a color profile correcting method for correcting a color profile having a first table for use in conversion from tone values to color values of image data, and a second table for use in conversion from color values to tone values of image data, and particularly for correcting the second table, the method comprising a converting step for converting first color values into tone values using the second table, and thereafter converting the tone values into second color values using the first table; a difference calculating step for calculating differences between the first color values and the second color values; a correcting step for correcting the second table based on the differences between the first color values and the second color values obtained in the difference calculating step; and a re-correcting step for executing the converting step, the difference calculating step and the correcting step using the second table corrected in the correcting step.

This color profile correcting method is capable of correcting the color profile promptly and properly without executing a printing operation.

The re-correcting step may be executed a plurality of times. Then, the color profile is corrected with increased accuracy.

The correcting step may be executed to obtain correction values by multiplying the differences between the first color values and the second color values by factors comprising positive numbers of at most 1, and correct the second table using the correction values.

Alternatively, the correcting step may be executed to correct the second table, using a table storing correction values corresponding to the differences between the, first color values and the second color values, and in particular using the correction values stored in the table.

In another aspect of the invention, a color profile correcting method is provided for correcting a color profile having a first table for use in conversion from tone values to color values of image data, and a second table for use in conversion from color values to tone values of image data, and particularly for correcting the first table, the method comprising a converting step for converting first tone values into color values using the first table, and thereafter converting the color values into second tone values using the second table; a difference calculating step for calculating differences between the first tone values and the second tone values; a correcting step for correcting the first table based on the differences between the first tone values and the second tone values obtained in the difference calculating step; and a re-correcting step for executing the converting step, the difference calculating step and the correcting step using the first table corrected in the correcting step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is an explanatory view schematically showing a color profile correcting method according to this invention; and

FIG. 2 is an explanatory view schematically showing a color profile correcting method in a different embodiment of this invention.

### DESCRIPTION OF THE PREFERRED EMBODIMENTS

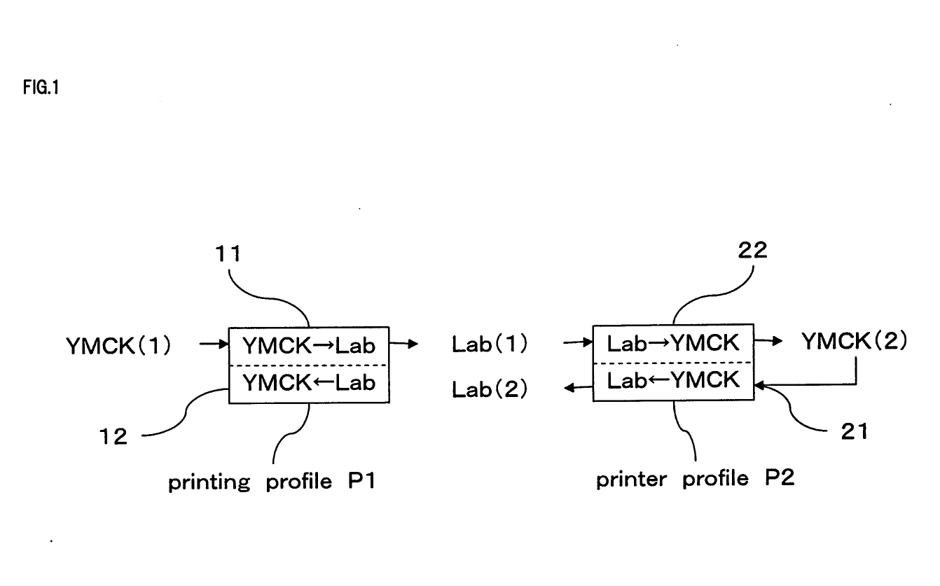

An embodiment of this invention will be described hereinafter with reference to the drawings. FIG. 1 is an explanatory view schematically showing a color profile correcting method according to this invention.

In FIG. 1, reference P1 denotes a printing profile which is a color profile for use in an ordinary offset press, and reference P2 denotes a printer profile which is a color profile used as a proof for a printer such as an ink-jet printer or laser printer.

The printing profile P1 includes a first table 11 serving as a lookup table for the conversion from tone values to color values of image data, and a second table 12 serving as a lookup table for the conversion from color values to tone values of image data. The following steps are executed to create this printing profile P1.

To create the first table 11 for the conversion from tone values to color values of image data, a color chart is first produced by using a printing machine. The color chart is based on known tone values of YMCK, and covers an entire printable coloring range in a gradually changing pattern. Next, each patch in this color chart is measured with a colorimeter to obtain data of a color value for each tone value. Then, an interpolation process is carried out based on this data, to obtain the first table 11 for the conversion from tone values to color values, covering a full range of tone values. On the other hand, when creating the second table 12 for the conversion from color values to tone values of image data, data of a tone value for each color value is derived from an arithmetic operation carried out by using an inverse function for each data in the first table 11.

The printer profile P2 includes a first table 21 serving as a lookup table for the conversion from tone values to color values of image data, and a second table 22 serving as a lookup table for the conversion from color values to tone values of image data. As in the case of the printing profile P1, the following steps are executed to create this printer profile P2.

To create the first table 21 for the conversion from tone values to color values of image data, a color chart is first produced by using a printer such as an ink-jet printer or laser printer. The color chart is based on known tone values of YMCK, and covers an entire printable coloring range in a gradually changing pattern. Next, each patch in this color chart is measured with a calorimeter to obtain data of a color value for each tone value. Then, an interpolation process is carried out based on this data, to obtain the first table 21 for the conversion from tone values to color values, covering a full range of tone values. On the other hand, when creating the second table 22 for the conversion from color values to tone values of image data, data of a tone value for each color value is derived from an arithmetic operation carried out by using an inverse function for each data in the first table 11.

These printing profile P1 and printer profile P2 are used as follows. When matching colors printed by a printer to colors printed by a printing machine, for example, and assuming that the tone values of the original image are YMCK (1) as shown in FIG. 1, these tone values YMCK (1) are converted into color values Lab (1) using the first table 11 in the printing profile P1. These color values Lab (1) are converted again into corrected tone values YMCK (2) using the second table 22 in the printer profile P2. In theory, a proper printing should be performed by the printer using these tone values YMCK (2). The same is the case when matching colors printed by the printing machine to colors printed by the printer.

However, as described above, the accuracy of the second table 22 in the printer profile P2 is not necessarily sufficient. In practice, therefore, satisfactory prints are not always available. In the color profile correcting method according to this invention, the second table 22 in the printer profile P2 is corrected through the following steps.

The tone values YMCK (1) of the original image are converted into the color values Lab (1) using the first table 11 in the printing profile P1, and then the color values Lab (1) are converted into the corrected tone values YMCK (2) using the second table 22 in the printer profile P2.

Next, a converting step is executed to convert these tone values YMCK (2) back into color values Lab (2), using the first table 21 in the printer profile P2.

Then, a difference calculating step is executed to compare and determine differences between the color values Lab (1) before the conversion and the color values Lab (2) after the conversion.

As described hereinbefore, the first table 21 in the printer profile P2 is considered to have the accuracy of conversion maintained at a relatively high level. Thus, the differences between the color values Lab (1) before the conversion and the color values Lab (2) after the conversion may be understood attributable to converting errors of the second table 22 in the printer profile P2.

The second table 22 in the printer profile P2 may be corrected to a proper form by correcting the data of the second table 22 based on the differences between the color values Lab (1) before the conversion and the color values Lab (2) after the conversion. Then, the above operation is performed again, using the corrected second table 22. The second table 22 may be further improved in accuracy by repeating a re-correcting step for re-correcting the second table 22 a plurality of times.

The correcting step and re-correcting step for correcting and re-correcting the second table 22 in the printer pro-file P2 based on differences between the color values Lab (1) before the conversion and the color values Lab (2) after the conversion will be described hereinafter.

Assume the respective color values Lab (1) before the conversion to be L(1), a(1) and b(1), and the respective color values Lab (2) after the conversion to be L(2), a(2) and b(2). Adjusted values of color differences in Lab space are calculated by multiplying the differences by weighting factors as shown in the following equations. The factors kL, ka and kb in the following equations are positive numbers not exceeding 1, preferably positive numbers smaller than 1, respectively.
ΔL=(L(1)−L(2))×kL
Δa=(a(1)−a(2))×ka
Δb=(b(1)−b(2))×kb

Then, as shown in the equations set out hereunder, corrected color values Lab (1′) are determined by subtracting from the original color values Lab (1) the adjusted values of color differences derived from the above equations. The correcting step is executed for correcting the second table 22 in the printer profile P2 based on these color values Lab (1′). The errors of the second table 22 occurring in time of its creation are thereby subtracted, to correct the printer profile P2 in a direction to converge the color differences.
L′=L(1)−ΔL
a′=a(1)−Δa
b′=b(1)−Δb

The color differences in Lab space are not in a perfectly linear relationship, and therefore the color differences cannot be converged completely by the above correcting step executed once. Thus, after correcting the second table 22 in the printer profile P2, the re-correcting step is executed to carry out again the converting step, difference calculating step and correcting step described above. Since the above factors kL, ka and kb are positive numbers not exceeding 1, preferably positive numbers smaller than 1, respectively, the re-correcting step is repeated to correct the color differences so as to reduce gradually (converge), and not to eliminate at once, the color differences.

Specifically, after converting the tone values YMCK (2) back to the color values Lab (2) using the corrected second table 22 in the printer profile P2, the color values Lab (1) before the conversion and the color values Lab (2) after the conversion are compared to determine differences therebetween, and the above calculations are carried out using these differences, thereby to correct the second table 22 in the printer profile P2 again. By executing this re-correcting step a plurality of times, the second table 22 in the printer profile P2 may be made more accurate. At this time, the correcting operation may be carried out simply, without actually executing a printing operation.

Next, a modified correcting step will be described. In the above embodiment, adjusted values are obtained by multiplying the differences between the first color values Lab (1) and second color values Lab (2) by the factors kL, ka and kb which are positive numbers not exceeding 1. The second table 22 in the printer profile P2 is corrected using these adjusted values.

On the other hand, this modified step uses a table storing adjusted values corresponding to the differences between the first color values Lab (1) and second color values Lab (2), and corrects the second table 22 in the printer profile P2 using the adjusted values stored in this table.

That is, a table storing adjusted values is created beforehand, which adjusted values correspond to differences (L(1)−L(2)), (a(1)−a(2)) and (b(1)−b(2)) between the first color values Lab (1) and second color values Lab (2). In the correcting step for correcting the second table 22 in the printer profile P2, adjusted values of the color differences corresponding to ΔL, Δa and Δb noted hereinbefore are determined by referring to this table.

Then, as in the foregoing embodiment, corrected color values Lab (1′) are obtained by subtracting the adjusted values of the color differences from the original color values Lab (1). The correcting step for correcting the second table 22 in the printer profile P2 is carried out based on these color values Lab (1′). Consequently, as in the foregoing embodiment, the errors occurring in the second table 22 in time of creation are subtracted so that the printer profile P2 becomes more accurate with the color differences converged.

Instead of obtaining adjusted values of the color differences using the calculations or the table, and subtracting the adjusted values from the original color values Lab (1), as in the embodiment and modification described above, the differences between the color values Lab (1) before the conversion and the color values Lab (2) after the conversion may be displayed, along with their images, on a monitor such as a CRT, and the operator, while looking at the monitor, may correct the data of the second table 22 in the printer profile P2.

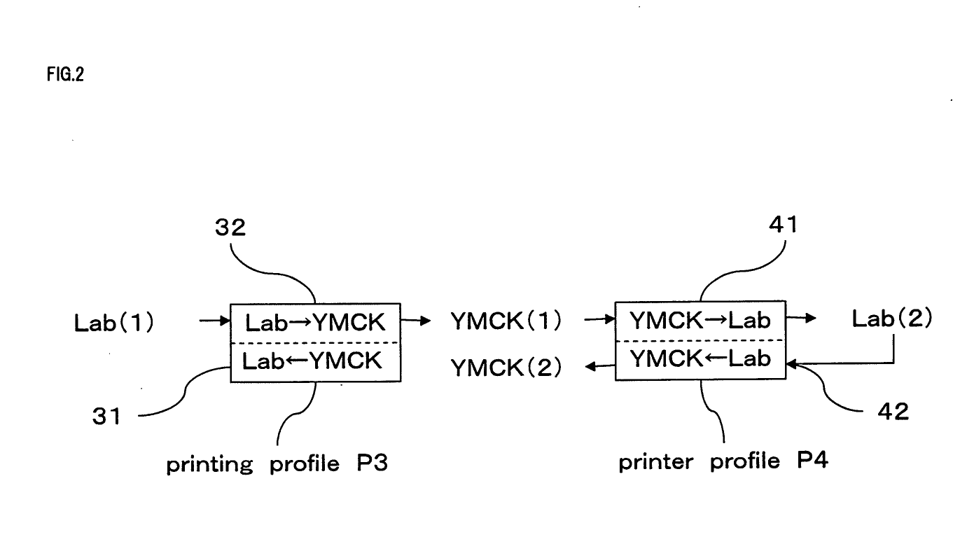

Next, a different embodiment of this invention will be described. FIG. 2 is an explanatory view schematically showing a color profile correcting method in the different embodiment of this invention.

The first embodiment described above corrects the second table for use in converting from the color values to the tone values of image data. This second embodiment corrects a first table for use in converting from the tone values to the color values of image data.

Where the tone values are four values of YMCK, accuracy lowers since the standard color system is three-dimensional. In this embodiment, therefore, steps similar to the steps described hereinbefore are executed with the value of K fixed to a certain value such as zero, or, K fluctuated quantitatively in accordance with a predetermined tone curve or a predetermined function.

As shown in FIG. 2, a printing profile P3 includes a first table 31 serving as a lookup table for the conversion from tone values to color values of image data, and a second table 32 serving as a lookup table for the conversion from color values to tone values of image data. This printing profile P3 is created by steps similar to those for creating the printing profile P1 described hereinbefore.

A printer profile P4 includes a first table 41 serving as a lookup table for the conversion from tone values to color values of image data, and a second table 42 serving as a lookup table for the conversion from color values to tone values of image data. To create this printer profile P4, steps similar to the case of the printing profile P3 are performed.

In this embodiment, the first table 41 in the printer profile P4 is corrected through the following steps.

The color values Lab (1) of the original image are converted into the tone values YMCK (1) using the second table 32 in the printing profile P3, and then the tone values YMCK (1) are converted into corrected color values Lab (2) using the first table 41 in the printer profile P4.

Next, a converting step is executed to convert these color values Lab (2) back into tone values YMCK (2), using the second table 42 in the printer profile P4.

Then, a difference calculating step is executed to compare and determine differences between the tone values YMCK (1) before the conversion and the tone values YMCK (2) after the conversion.

The first table 41 in the printer profile P4 is corrected to a proper form by correcting the data of the first table 41 based on the differences between the tone values YMCK (1) before the conversion and the tone values YMCK (2) after the conversion. Subsequently, the above operation is carried out again, using the corrected first table 41. The first table 41 may be further improved in accuracy by repeating a re-correcting step for re-correcting the first table 41 a plurality of times.

The correcting step and re-correcting step for correcting and re-correcting the first table 41 in the printer profile P4 based on differences between the tone values YMCK (1) before the conversion and the tone values YMCK (2) after the conversion will be described hereinafter.

Assume the respective tone values YMCK (1) before the conversion, excluding K, to be Y(1), M(1) and C(1), and the respective tone values YMCK (2) after the conversion, excluding K, to be Y(2), M(2) and C(2). Adjusted values of tone differences are calculated by multiplying the differences by weighting factors as shown in the following equations. The factors kY, kM and kC in the following equations are positive numbers not exceeding 1, preferably positive numbers smaller than 1, respectively.
ΔY=(Y(1)−Y(2))×kY
ΔM=(M(1)−M(2))×kM
ΔC=(C(1)−C(2))×kC

Then, as shown in the equations set out hereunder, corrected tone values YMCK (1′) are determined by subtracting from the original tone values YMCK (1) the adjusted values of tone differences derived from the above equations. The correcting step is executed for correcting the first table 41 in the printer profile P4 based on these tone values YMCK (1′). The errors of the first table 41 occurring in time of its creation are thereby subtracted, to correct the printer profile P4 in a direction to converge the tone differences.
Y′=Y(1)−ΔY
M′=M(1)−ΔM
C′=C(1)−ΔC

After correcting the first table 41 in the printer pro-file P4, the re-correcting step is executed to carry out again the converting step, difference calculating step and correcting step described above. Since the above factors kY, kM and kC are positive numbers not exceeding 1, preferably positive numbers smaller than 1, respectively, the re-correcting step is repeated to correct the tone differences so as to reduce gradually (converge), and not to eliminate at once, the tone differences.

Specifically, after converting the color values Lab (2) back to the tone values YMCK (2) using the corrected first table 41 in the printer profile P4, the tone values YMCK (1) before the conversion and the tone values YMCK (2) after the conversion are compared to determine differences therebetween, and the above calculations are carried out using these differences, thereby to correct the first table 41 in the printer profile P4 again. By executing this re-correcting step a plurality of times, the first table 41 in the printer profile P4 may be made more accurate. At this time, the correcting operation may be carried out simply, without actually executing a printing operation.

Next, a modified correcting step will be described. In the above embodiment, adjusted values are obtained by multiplying the differences between the first tone values YMCK (1) and second tone values YMCK (2) by the factors kY, kM and kC which are positive numbers not exceeding 1. The first table 41 in the printer profile P4 is corrected using these adjusted values.

On the other hand, this modified uses a table storing adjusted values corresponding to the differences between the first tone values YMCK (1) and second tone values YMCK (2), and corrects the first table 41 in the printer profile P4 using the adjusted values stored in this table.

That is, a table storing adjusted values is created beforehand, which adjusted values correspond to differences (Y(1)−Y (2)), (M(1)−M(2)) and (C(1)−C(2)) between the first tone values YMCK (1) and second tone values YMCK (2). In the correcting step for correcting the first table 41 in the printer profile P4, adjusted values of the tone differences corresponding to ΔY, ΔM and ΔC noted hereinbefore are determined by referring to this table.

Then, as in the foregoing embodiment, corrected tone values YMCK (1′) are obtained by subtracting the adjusted values of the tone differences from the original tone values YMCK (1). The correcting step for correcting the first table 41 in the printer profile P4 is carried out based on these tone values YMCK (1′). Consequently, as in the foregoing embodiment, the errors occurring in the first table 41 in time of creation are subtracted so that the printer profile P4 becomes more accurate with the tone differences converged.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-002267 filed in the Japanese Patent Office on Jan. 7, 2004, the entire disclosure of which is incorporated herein by reference.

1. A color profile correcting method for correcting a color profile having a first table for use in conversion from tone values to color values of image data, and a second table for use in conversion from color values to tone values of image data, and particularly for correcting said second table, said method comprising:
a converting step for converting first color values into tone values using said second table, and thereafter converting said tone values into second color values using said first table;
a difference calculating step for calculating differences between said first color values and said second color values;
a correcting step for correcting said second table based on the differences between said first color values and said second color values obtained in said difference calculating step; and
a re-correcting step for executing said converting step, said difference calculating step and said correcting step using the second table corrected in said correcting step.

2. A color profile correcting method as defined in claim 1, wherein said re-correcting step is executed a plurality of times.

3. A color profile correcting method as defined in claim 2, wherein said correcting step is executed to obtain correction values by multiplying the differences between said first color values and said second color values by factors comprising positive numbers of at most 1, and correct said second table using said correction values.

4. A color profile correcting method as defined in claim 2, wherein said correcting step is executed to correct said second table, using a table storing correction values corresponding to the differences between said first color values and said second color values, and in particular using the correction values stored in said table.

5. A color profile correcting method for correcting a color profile having a first table for use in conversion from tone values to color values of image data, and a second table for use in conversion from color values to tone values of image data, and particularly for correcting said first table, said method comprising:
a converting step for converting first tone values into color values using said first table, and thereafter converting said color values into second tone values using said second table;
a difference calculating step for calculating differences between said first tone values and said second tone values;
a correcting step for correcting said first table based on the differences between said first tone values and said second tone values obtained in said difference calculating step; and
a re-correcting step for executing said converting step, said difference calculating step and said correcting step using the first table corrected in said correcting step.

6. A color profile correcting method as defined in claim 1, wherein said tone values comprise YMCK values, the value of K being fixed in said converting step, said difference calculating step and said correcting step.

7. A color profile correcting method as defined in claim 6, wherein said re-correcting step is executed a plurality of times.

8. A color profile correcting method as defined in claim 7, wherein said correcting step is executed to obtain correction values by multiplying the differences between said first tone values and said second tone values by factors comprising positive numbers of at most 1, and correct said first table using said correction values.

9. A color profile correcting method as defined in claim 7, wherein said correcting step is executed to correct said first table, using a table storing correction values corresponding to the differences between said first tone values and said second tone values, and in particular using the correction values stored in said table.
